(19) United States
(12) Patent Application Publication
(10) Pub. No.: US 2021/0179030 A1
(43) Pub. Date: Jun. 17, 2021

(54) VEHICULAR CLEANER SYSTEM AND VEHICLE HAVING VEHICULAR CLEANER SYSTEM

(71) Applicant: KOITO MANUFACTURING CO., LTD., Tokyo (JP)

(72) Inventors: Masaru SAKAI, Shizuoka-shi, Shizuoka (JP); Yasuhiro ICHIKAWA, Shizuoka-shi, Shizuoka (JP)

(73) Assignee: KOITO MANUFACTURING CO., LTD., Tokyo (JP)

(21) Appl. No.: 16/479,657

(22) PCT Filed: Jan. 16, 2018
(86) PCT No.: PCT/JP2018/000962

§ 371 Date: Jul. 22, 2019

(30) Foreign Application Priority Data
Jan. 23, 2017 (JP) 2017-009254

(51) Int. Cl. B60S 1/52; B60S 1/60

(52) U.S. Cl. CPC B60S 1/528; B60S 1/0848; B60S 1/603

(57) ABSTRACT

The vehicular cleaner system is provided with: a tank (2) for storing a cleaning fluid; a motor pump (3) for pumping out the cleaning fluid in the tank (2); lighting fixture nozzles (4) for spraying the cleaning fluid toward headlamps (100); sensor nozzles (5) for spraying the cleaning fluid toward on-board sensors (200); a cleaning fluid passage (9) that connects the motor pump (3) to the lighting fixture nozzles (4) and the sensor nozzles (5); and a controller (8) for controlling the spraying of the cleaning fluid.

### TECHNICAL FIELD

The present invention relates to a vehicular cleaner system configured to clean a to-be-cleaned object and a vehicle having a vehicular cleaner system.

### BACKGROUND ART

In recent years, vehicles having a vehicle-mounted camera configured to capture a situation around a vehicle have been increasing. A lens, which is an imaging surface, of the vehicle-mounted camera may be smudged due to rain, mud and the like. For this reason, in order to remove foreign matters such as water droplets attached on the lens, a device configured to remove the foreign matters by ejecting a cleaning liquid, a compressed air and the like to the lens of the vehicle-mounted camera has been known.

For example, Patent Document 1 discloses a configuration where a compressed air generation unit is provided in the vicinity of the vehicle-mounted camera, and a compressed air of the compressed air generation unit is sprayed from a nozzle to eject a high-pressure air to a front glass of the vehicle-mounted camera, thereby removing water droplets attached on the front glass (refer to Patent Document 1).

Also, a headlamp cleaner configured to detach contaminants and snow attached to a headlamp by spraying a cleaning liquid to the headlamp of a vehicle has been known.

### CITATION LIST

### Patent Document

Patent Document 1: JP-A-2001-171491

### SUMMARY OF INVENTION

### Technical Problem

In the related art, a foreign matter removing device of a vehicle-mounted camera and a headlamp cleaner are mounted to the vehicle, as separate devices to be independently controlled. However, there is a room for improvement on the configurations thereof.

An object of the present invention is to provide a vehicular cleaner system capable of removing foreign matters attached to a plurality of types of to-be-cleaned objects with simple configuration and control, and a vehicle having the vehicular cleaner system.

### Solution to Problem

In order to achieve the above object, a vehicular cleaner system of the present invention includes:

a tank configured to accommodate therein a cleaning liquid;

a pump configured to pressure-feed the cleaning liquid in the tank;

a first nozzle configured to spray the cleaning liquid toward a first to-be-cleaned object;

a second nozzle configured to spray the cleaning liquid toward a second to-be-cleaned object different from the first to-be-cleaned object;

a cleaning liquid passage configured to connect the pump to the first nozzle and the second nozzle, and

a controller configured to control the spraying of the cleaning liquid.

According to the above configuration, it is possible to remove foreign matters attached to the plurality of types of to-be-cleaned objects with the simple configuration and control.

Also, in the vehicular cleaner system of the present invention,

the cleaning liquid passage may have a bifurcation part for supplying the cleaning liquid from the pump to each of the first nozzle and the second nozzle, and

an electromagnetic valve of which opening and closing can be controlled by the controller may be provided in the vicinity of the bifurcation part.

According to the above configuration, it is possible to appropriately control cleaning timings of different to-be-cleaned objects by controlling the opening and closing of the electromagnetic valve.

Also, in the vehicular cleaner system of the present invention,

the electromagnetic valve may be arranged on the way of the cleaning liquid passage facing from the bifurcation part toward the first nozzle.

According to the above configuration, when the electromagnetic valve is opened, the cleaning liquid can be sprayed from both the first nozzle and the second nozzle, and when the electromagnetic valve is closed, the cleaning liquid can be sprayed from only the second nozzle.

Also, in the vehicular cleaner system of the present invention,

the first to-be-cleaned object may be a vehicular lamp, and

the second to-be-cleaned object may be a vehicle-mounted sensor that is to be mounted to a vehicle.

According to the above configuration, for example, it is possible to clean even the vehicle-mounted sensor by extending a cleaner configuration of the vehicular lamp of the related art.

Also, in the vehicular cleaner system of the present invention,

the controller may be configured to spray the cleaning liquid from the second nozzle, in synchronization with an actuation of a window washer for cleaning a window of the vehicle or on the basis of a smudge detection result of the vehicle-mounted sensor.

According to the above configuration, it is possible to appropriately clean the vehicle-mounted sensor, when needed, irrespective of a cleaning timing of the vehicular lamp.

Also, in the vehicular cleaner system of the present invention,

when the vehicular lamp is in a lights-out state, the controller may close the electromagnetic valve, and when the vehicular lamp is turned on, the controller may open the electromagnetic valve.

According to the above configuration, when the vehicular lamp is in the lights-out state, only the vehicle-mounted sensor can be cleaned, and when the vehicular lamp is turned on, the vehicular lamp can be cleaned, in addition to the vehicle-mounted sensor.

Also, in the vehicular cleaner system of the present invention,

the second nozzle may have a check valve, and

a valve opening pressure of the second nozzle may be set higher than a valve opening pressure of the first nozzle.

According to the above configuration, it is possible to suppress consumption of the cleaning liquid at the vehicle-mounted sensor-side having a relatively smaller to-be-cleaned area, as compared to the vehicular lamp.

Also, in the vehicular cleaner system of the present invention,

the pump may have a first ejection port through which the cleaning liquid is to be ejected upon forward rotation of the pump, and a second ejection port through which the cleaning liquid is to be ejected upon reverse rotation of the pump, and

the cleaning liquid passage may be configured by a first passage configured to connect the first ejection port and the first nozzle therebetween, and a second passage configured to connect the second ejection port and the second nozzle therebetween.

According to the above configuration, it is possible to appropriately clean different to-be-cleaned objects by controlling a rotating direction of the pump.

Also, in the vehicular cleaner system of the present invention,

an ejection pressure of the cleaning liquid from the first ejection port may be set higher than an ejection pressure of the cleaning liquid from the second ejection port.

According to the above configuration, it is possible to suppress consumption of the cleaning liquid at the vehicle-mounted sensor-side having a relatively smaller to-be-cleaned area, as compared to the vehicular lamp.

Also, in the vehicular cleaner system of the present invention,

the first to-be-cleaned object may be a vehicular lamp,

the second to-be-cleaned object may be a vehicle-mounted sensor that is to be mounted to a vehicle, and

the controller may be configured to determine whether the vehicular lamp is turned on or not, and to control a rotating direction of the pump, based on any one of a result of the determination as to whether the lighting or lights-out, an on/off state of an actuation switch of the vehicular cleaner system, an actuation state of a window washer for cleaning a window of the vehicle, and a smudge detection result of the vehicle-mounted sensor.

According to the above configuration, it is possible to appropriately switch the cleaning of the vehicular lamp and the cleaning of the vehicle-mounted sensor by controlling the rotating direction of the pump in accordance with a variety of information.

Also, in the vehicular cleaner system of the present invention,

the first to-be-cleaned object may be a window of a vehicle, and

the second to-be-cleaned object may be at least one of a vehicular lamp and a vehicle-mounted sensor.

According to the above configuration, it is possible to clean even the vehicular lamp or the vehicle-mounted sensor by extending a configuration of the window washer of the related art.

Also, the vehicular cleaner system of the present invention may further include:

a high-pressure air generation unit configured to generate a high-pressure air, and

a third nozzle configured to spray the high-pressure air toward the second to-be-cleaned object, and

the controller may be configured to execute the spraying of the cleaning liquid from the second nozzle and the spraying of the high-pressure air from the third nozzle in a duplicate or switching manner.

According to the above configuration, it is possible to further effectively remove foreign matters attached to the second to-be-cleaned object.

Also, in the vehicular cleaner system of the present invention,

the controller may be configured to initiate the spraying of the high-pressure air from the third nozzle after the spraying of the cleaning liquid from the second nozzle has been initiated.

According to the above configuration, it is possible to remove water droplets attached to the vehicle-mounted sensor, for example, upon the cleaning.

Also, in the vehicular cleaner system of the present invention,

the vehicle-mounted sensor may include at least one of a vehicle-mounted camera, a millimeter wave radar, and a LiDAR.

According to the above configuration, it is favorable to clean the sensors with the vehicular cleaner system, which is the same as that of the vehicular lamp or the vehicular window.

Also, a vehicle having a vehicular cleaner of the present invention includes the vehicular cleaner having any one of the above configurations.

According to the above configuration, it is possible to effectively remove the foreign matters attached to the to-be-cleaned object with the simple configuration.

### Advantageous Effects of Invention

According to the vehicular cleaner system of the present invention, it is possible to effectively remove the foreign matters attached to the to-be-cleaned object with the simple configuration. Also, according to the vehicle having a vehicular cleaner system of the present invention, it is possible to effectively remove the foreign matters attached to the to-be-cleaned object with the simple configuration.

### BRIEF DESCRIPTION OF DRAWINGS

FIG. 1 is a perspective view of a front part of a vehicle having a vehicular cleaner system in accordance with an exemplary embodiment of the present invention.

FIG. 2 depicts a configuration of the vehicular cleaner system.

FIG. 3 depicts a cleaning liquid passage of the vehicular cleaner system shown in FIG. 2.

FIG. 4 is a timing chart for illustrating operations of the vehicular cleaner system.

FIG. 5 depicts a modified embodiment of an arrangement of an electromagnetic valve on the cleaning liquid passage.

FIG. 6 depicts a modified embodiment of the vehicular cleaner system.

### DESCRIPTION OF EMBODIMENTS

Hereinafter, an example of an exemplary embodiment with be described with reference to the drawings.

A vehicular cleaner system of the present invention is applied as a system configured to remove foreign matters such as water droplets, mud, grit and dust and the like attached to a vehicular lamp mounted to a vehicle, a vehicle-mounted sensor, a window of a vehicle or the like (examples of the to-be-cleaned object) by using a cleaning liquid and a high-pressure air. Here, the window of the vehicle is a concept including a windshield, a rear glass, a front side glass, a rear side glass, a sunroof and the like. In the exemplary embodiment, the windshield is particularly exemplified.

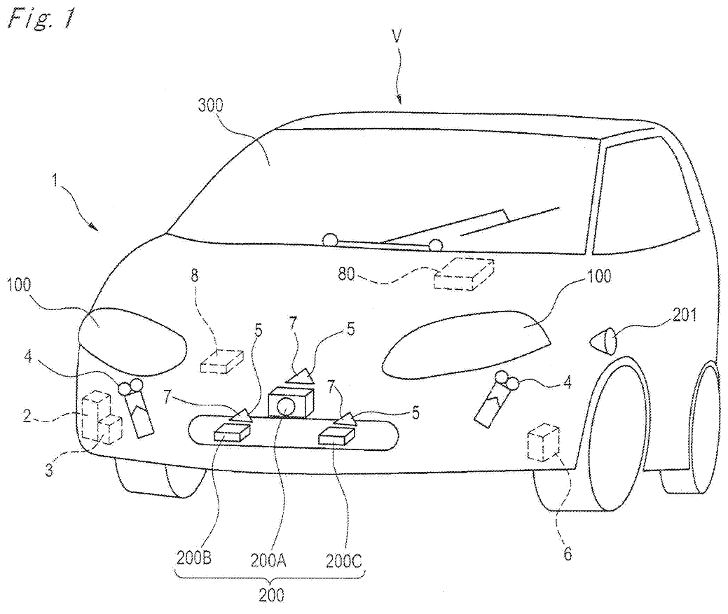

As shown in FIG. 1, the vehicular cleaner system 1 can be used to remove the foreign matters attached to a headlamp 100 (an example of the vehicular lamp), a front camera 200A (an example of the vehicle-mounted sensor), a millimeter wave radar 200B (an example of the vehicle-mounted sensor), and a LiDAR 200C (an example of the vehicle-mounted sensor), which are mounted to a front part of a vehicle V, for example.

The front camera 200A is a vehicle-mounted camera configured to capture a situation (image) ahead of the vehicle. The millimeter wave radar 200B is a collision prevention radar configured to detect a target ahead of the vehicle. The LiDAR (Light Detection and Ranging, Laser Imaging Detection and Ranging) 200C is a sensor capable of acquiring information such as a distant to an object, a shape of the object, a material of the object, a color of the object and the like, based on emitted light and return light. The front camera 200A, the millimeter wave radar 200B, and the LiDAR 200C are collectively referred to as a vehicle-mounted sensor 200. The vehicle-mounted sensor 200 can be used for automatic driving, for example. In addition, the vehicle-mounted sensor includes a side camera 201 mounted to a fender so as to check the rear, for example. In the meantime, the arrangement of the vehicle-mounted camera 200 is not limited to FIG. 1.

The vehicular cleaner system 1 includes a tank 2 configured to accommodate therein a cleaning liquid, and a motor pump 3 (an example of the pump) configured to pressure-feed the cleaning liquid in the tank 2. In the meantime, the tank 2 and the motor pump 3 may be configured to function as a tank and a motor pump of a window washer device provided so as to clean a windshield 300, too.

Also, the vehicular cleaner system 1 includes a nozzle 4 for a lamp (an example of the first nozzle) configured to spray the cleaning liquid toward the headlamp 100 (an example of the first to-be-cleaned object), and a nozzle 5 for a sensor (an example of the second nozzle) configured to spray the cleaning liquid toward the vehicle-mounted sensor 200 (an example of the second to-be-cleaned object).

Also, the vehicular cleaner system 1 includes a high-pressure air generation unit 6 configured to generate a high-pressure air, and a high-pressure air nozzle 7 (an example of the third nozzle) configured to spray the generated high-pressure air toward the vehicle-mounted sensor 200.

Also, the vehicular cleaner system 1 includes a controller 8 configured to control operations of the respective units. The controller 8 is configured to control operations of the vehicular cleaner system 1 in cooperation with a vehicle ECU 80 (Electronic Controller) of the vehicle V Meanwhile, in this example, the controller 8 is independently provided.

However, a configuration where the processing of the controller 8 is executed by the vehicle ECU 80 and the controller is thus integrated is also possible.

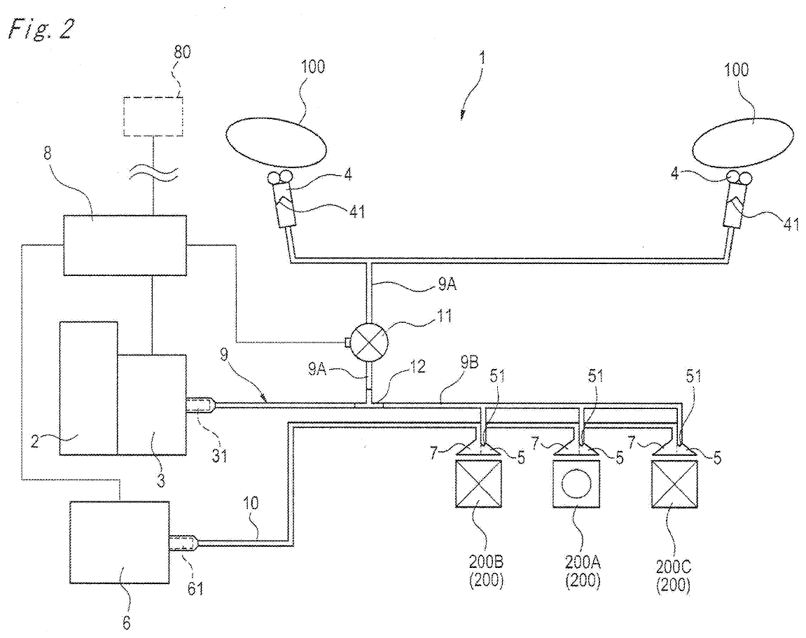

As shown in FIG. 2, the motor pump 3 has a single cleaning liquid ejection port 31 for ejecting the cleaning liquid. The cleaning liquid ejection port 31 is coupled with a cleaning liquid passage 9 through which the ejected cleaning liquid is to pass. The motor pump 3 is connected to the nozzle 4 for a lamp and the nozzle 5 for a sensor through the cleaning liquid passage 9. The motor pump 3 is configured to deliver the cleaning liquid supplied from the tank 2 to the nozzle 4 for a lamp and the nozzle 5 for a sensor through the cleaning liquid passage 9.

The cleaning liquid passage 9 is bifurcated to a cleaning liquid passage 9A facing toward the nozzle 4 for a lamp and a cleaning liquid passage 9B facing toward the nozzle 5 for a sensor. The cleaning liquid passage 9A is provided on the way with an electromagnetic valve 11 configured to open and close the cleaning liquid passage 9A, thereby controlling a flow rate of the cleaning liquid to flow toward the nozzle 4 for a lamp.

The nozzle 4 for a lamp and the nozzle 5 for a sensor are mounted with a check valve 41 and a check valve 51 capable of controlling a flow rate of the cleaning liquid to flow through each nozzle, respectively. A valve opening pressure of the check valve 51 mounted to the nozzle 5 for a sensor is set higher than a valve opening pressure of the check valve 41 mounted to the nozzle 4 for a lamp. Therefore, for example, regarding the cleaning liquid pressure-fed from the motor pump 3, a small flow rate of the cleaning liquid is sprayed from the nozzle 5 for a sensor having a higher valve opening pressure than the nozzle 4 for a lamp having a low valve opening pressure. In the meantime, the nozzle 4 for a lamp may not be mounted with the check valve 41, and, for example, the opening and closing states of the electromagnetic valve 11 provided on the way of the cleaning liquid passage 9A may be controlled to adjust a flow rate of the cleaning liquid to be sprayed from the nozzle 4 for a lamp.

The high-pressure air generation unit 6 has a single high-pressure air ejection port 61 for ejecting a high-pressure air. The high-pressure air ejection port 61 is coupled with a high-pressure air passage 10 through which the ejected high-pressure air is to pass. The high-pressure air generation unit 6 is connected to the high-pressure air nozzle 7 through the high-pressure air passage 10. The high-pressure air generation unit 6 is configured to deliver the generated high-pressure air to the high-pressure air nozzle 7 through the high-pressure air passage 10.

Meanwhile, in this example, the high-pressure air generation unit 6 is provided with the single high-pressure air ejection port, and the high-pressure air is sprayed to the front camera 200A, the millimeter wave radar 200B, and the LiDAR 200C through the one same high-pressure air passage 10 at the same timing. However, the present invention is not limited thereto. For example, a plurality of high-pressure air ejection ports and high-pressure air passages each of which is coupled to each of the high-pressure air ejection ports may be provided, and the high-pressure air may be sprayed to each vehicle-mounted sensor 200.

The nozzle 5 for a sensor configured to spray the cleaning liquid and the high-pressure air nozzle 7 configured to spray the high-pressure air toward the vehicle-mounted sensor 200 may coexist in one housing or each may be configured as an independent separate nozzle. In this example, the nozzle 5 for a sensor and the high-pressure air nozzle 7 are provided in one housing. Positions of the nozzles are not limited to the shown example. However, considering a traveling wind and the like upon traveling of the vehicle, the nozzles are preferably arranged at any one side of upper and lower sides of the vehicle-mounted sensor 200. Also, when the nozzle 5 for a sensor and the high-pressure air nozzle 7 are configured as independent separate nozzles, preferably, the nozzle 5 for a sensor is arranged at one side of left and right sides of the vehicle-mounted sensor 200 and the high-pressure air nozzle 7 is arranged at one side of upper and lower sides of the vehicle-mounted sensor 200, from standpoints of the traveling wind and cleaning efficiency.

The controller 8 is connected to the motor pump 3 and the high-pressure air generation unit 6. For example, the controller 8 can spray the cleaning liquid from the nozzle 4 for a lamp and the nozzle 5 for a sensor by controlling the motor pump 3. Also, the controller 8 can spray the high-pressure air from the high-pressure air nozzle 7 by controlling the high-pressure air generation unit 6. Also, the controller 8 can execute the spraying of the cleaning liquid from the nozzle 5 for a sensor and the spraying of the high-pressure air from the high-pressure air nozzle 7 in a duplicate or switching manner by controlling the motor pump 3 and the high-pressure air generation unit 6. Specifically, when cleaning the vehicle-mounted sensor 200, the spraying of the high-pressure air from the high-pressure air nozzle 7 may be initiated after the spraying of the cleaning liquid from the nozzle 5 for a sensor has been initiated. Also, the spraying of the high-pressure air from the high-pressure air nozzle 7 may be performed after the spraying of the cleaning liquid from the nozzle 5 for a sensor has been completed.

Also, the controller 8 is connected to the electromagnetic valve 11. For example, the controller 8 can control opening and closing of the electromagnetic valve 11 in accordance with lighting and lights-out of the headlamp 100. Specifically, when the headlamp 100 is in a lighting state, the electromagnetic valve 11 is opened, and when the headlamp 100 is in a lights-out state, the electromagnetic valve 11 is closed.

In addition, the controller 8 is connected to the vehicle ECU 80. For example, the controller 8 is configured to control operations of the respective units, based on operation information and the like of the vehicle V transmitted from the vehicle ECU 80. The vehicle V is provided with a lamp switch for turning on and off the headlamp and a lamp cleaning switch for cleaning the headlamp, which switches can be operated by a driver, for example. Also, the vehicle V is provided with a sensor cleaning switch for cleaning the vehicle-mounted sensor 200, for example. Also, the vehicle V is provided with a windshield cleaning switch for cleaning the windshield 300, for example.

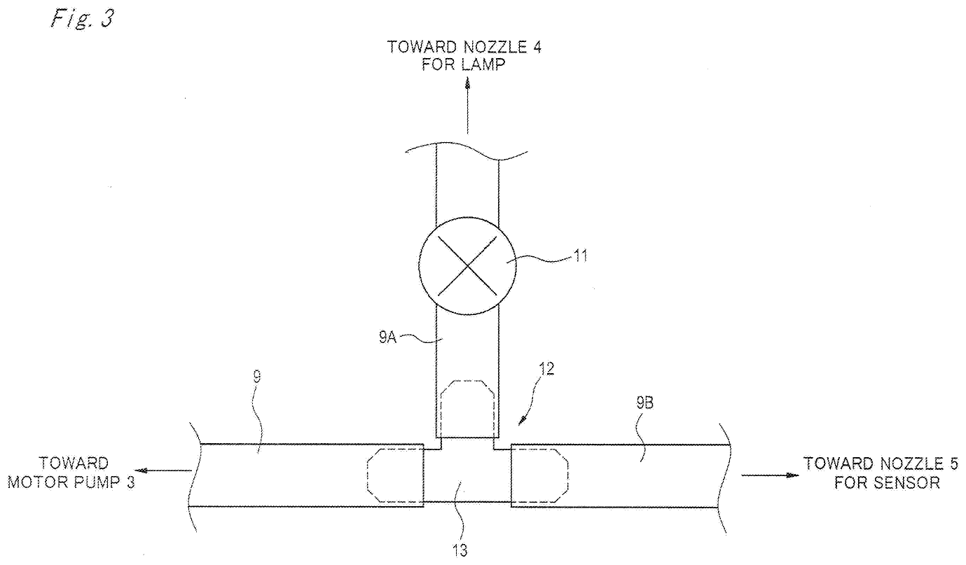

As shown in FIG. 3, a bifurcation part 12 from which the cleaning liquid passage 9 is bifurcated is attached with a bifurcation member 13 for bifurcating the cleaning liquid passage 9 into the two passages of the cleaning liquid passage 9A and the cleaning liquid passage 9B. The electromagnetic valve 11 capable of controlling flow in the cleaning liquid passage 9A is provided in the vicinity of the bifurcation part 12. In this example, the bifurcation member 13 having a T-shape is used.

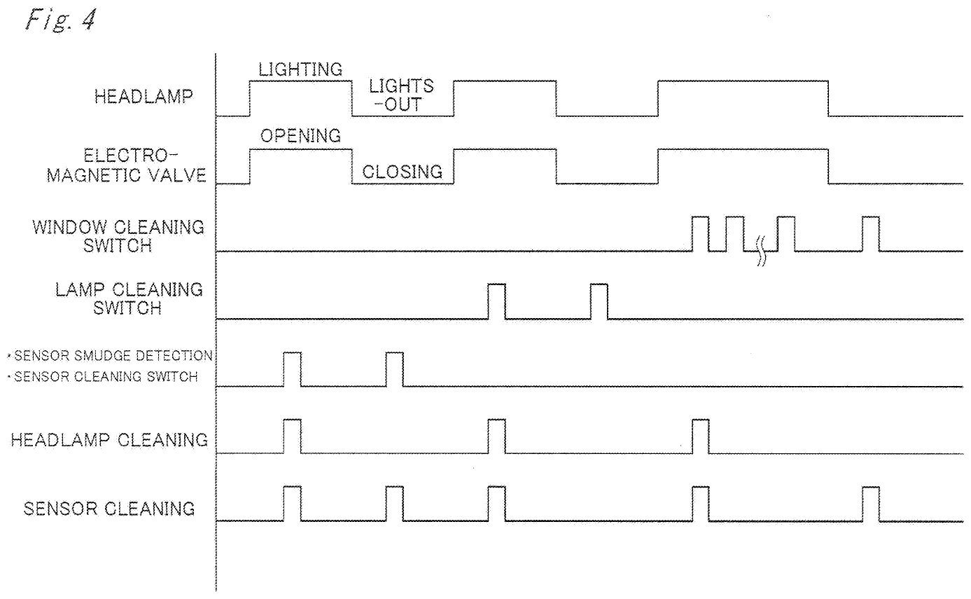

Subsequently, operations of the vehicular cleaner system 1 are described with reference to FIGS. 4 and 2.

For example, when the lamp switch is subjected to an on-operation and the headlamp 100 is thus turned on, a lamp lighting signal is transmitted from the vehicle ECU 80 to the controller 8. The controller 8 having received the lamp lighting signal opens the electromagnetic valve 11 provided on the cleaning liquid passage 9A.

For example, when the vehicle-mounted sensor 200 is recognized as being smudged in the lighting state of the headlamp 100, a smudge detection signal is transmitted from the vehicle ECU 80 to the controller 8. Whether the sensor is smudged is recognized by analyzing image data captured by the front camera 200A, for example.

The controller 8 having received the smudge detection signal controls the motor pump 3 to deliver the cleaning liquid in the tank 2 to the nozzle 4 for a lamp and the nozzle 5 for a sensor through the cleaning liquid passage 9. The cleaning liquid is sprayed from the nozzle 4 for a lamp toward the headlamp 100, so that the headlamp 100 is cleaned by the cleaning liquid. Also, the cleaning liquid is sprayed from the nozzle 5 for a sensor toward the vehicle-mounted sensor 200, so that the vehicle-mounted sensor 200 is cleaned by the cleaning liquid.

Also, the controller 8 having received the smudge detection signal controls the high-pressure air generation unit 6 to deliver the high-pressure air to the high-pressure air nozzle 7 through the high-pressure air passage 10. The high-pressure air is sprayed from the high-pressure air nozzle 7 toward the vehicle-mounted sensor 200, so that the vehicle-mounted sensor 200 is cleaned by the high-pressure air.

The cleaning of the vehicle-mounted sensor 200 by the cleaning liquid and the high-pressure air is performed in such a way that the cleaning of the high-pressure air by the high-pressure air nozzle 7 is performed after the cleaning of the cleaning liquid by the nozzle 5 for a sensor has been completed, for example.

Also, for example, when the sensor cleaning switch is subjected to an on-operation in the lighting state of the headlamp 100, a sensor cleaning signal is transmitted from the vehicle ECU 80 to the controller 8. The control that is performed by the controller 8 having received the sensor cleaning signal is the same as the case where the controller 8 receives the smudge detection signal, so that the headlamp 100 is cleaned by the spraying of the cleaning liquid and the vehicle-mounted sensor 200 is cleaned by the spraying of the cleaning liquid and the high-pressure air.

Also, for example, when the lamp switch is subjected to an off-operation and the headlamp 100 is thus turned off, a lamp lights-out signal is transmitted from the vehicle ECU 80 to the controller 8. The controller 8 having received the lamp lights-out signal closes the electromagnetic valve 11 provided on the cleaning liquid passage 9A.

For example, when the vehicle-mounted sensor 200 is recognized as being smudged in the lights-out state of the headlamp 100, a smudge detection signal is transmitted from the vehicle ECU 80 to the controller 8.

The controller 8 having received the smudge detection signal controls the motor pump 3 to deliver the cleaning liquid in the tank 2 to the cleaning liquid passage 9. In this case, since the electromagnetic valve 11 provided on the cleaning liquid passage 9A is closed, the cleaning liquid delivered to the cleaning liquid passage 9 flows only through the cleaning liquid passage 9B without flowing through the cleaning liquid passage 9A. The cleaning liquid is delivered to the nozzle 5 for a sensor through the cleaning liquid passage 9B, and is sprayed from the nozzle 5 for a sensor toward the vehicle-mounted sensor 200. Thereby, the vehicle-mounted sensor 200 is cleaned by the cleaning liquid.

The control that is performed for the high-pressure air generation unit 6 by the controller 8 having received the smudge detection signal is the same as the case where the controller 8 receives the smudge detection signal, so that the vehicle-mounted sensor 200 is cleaned by the spraying of the high-pressure air.

Also, for example, when the lamp cleaning switch is subjected to an on-operation in the lighting state of the headlamp 100, a lamp cleaning signal is transmitted from the vehicle ECU 80 to the controller 8. The control that is performed by the controller 8 having received the lamp cleaning signal is the same as the case where the vehicle-mounted sensor 200 is detected as being smudged and the controller 8 receives the smudge detection signal, so that the headlamp 100 is cleaned by the spraying of the cleaning liquid and the vehicle-mounted sensor 200 is cleaned by the spraying of the cleaning liquid and the high-pressure air.

Also, for example, when the lamp cleaning switch is subjected to the on-operation in the lights-out state of the headlamp 100, a lamp cleaning signal is transmitted from the vehicle ECU 80 to the controller 8.

In this case, since the headlamp 100 is turned off, the controller 8 does not perform the control on the motor pump 3 and the high-pressure air generation unit 6. Therefore, the headlamp 100 and the vehicle-mounted sensor 200 are not cleaned.

Also, for example, when the windshield cleaning switch is subjected to an on-operation in the lighting state of the headlamp 100, a windshield cleaning signal is transmitted from the vehicle ECU 80 to the controller 8. The control that is performed by the controller 8 having received the windshield cleaning signal is the same as the case where the vehicle-mounted sensor 200 is detected as being smudged and the controller 8 receives the smudge detection signal, so that the headlamp 100 is cleaned by the spraying of the cleaning liquid and the vehicle-mounted sensor 200 is cleaned by the spraying of the cleaning liquid and the high-pressure air. The controller 8 sprays the cleaning liquid from the nozzle 4 for a lamp and the nozzle 5 for a sensor, in synchronization (cooperation) with the actuation of the window washer configured to clean the windshield 300, for example.

In the meantime, the cleaning of the headlamp 100 and the vehicle-mounted sensor 200 in cooperation with the on-operation (the cleaning of the windshield 300) of the windshield cleaning switch is not necessarily required to be executed every time. For example, the cleaning of the headlamp 100 and the vehicle-mounted sensor 200 may be executed once per several cleaning times of the windshield.

Also, for example, when the windshield cleaning switch is subjected to the on-operation in the lights-out state of the headlamp 100, a windshield cleaning signal is transmitted from the vehicle ECU 80 to the controller 8.

The control that is performed by the controller 8 having received the windshield cleaning signal is the same as the case where the vehicle-mounted sensor 200 is detected as being smudged and the controller 8 receives the smudge detection signal, so that the headlamp 100 is not cleaned and the vehicle-mounted sensor 200 is cleaned by the spraying of the cleaning liquid and the high-pressure air. The controller 8 sprays the cleaning liquid from the nozzle 5 for a sensor, in synchronization (cooperation) with the actuation of the window washer configured to clean the windshield 300, for example.

The vehicular cleaner system 1 configured as described above includes the tank 2 configured to accommodate therein the cleaning liquid, the motor pump 3 configured to pressure-feed the cleaning liquid in the tank 2, the nozzle 4 for a lamp configured to spray the cleaning liquid toward the headlamp 100, the nozzle 5 for a sensor configured to spray the cleaning liquid toward the vehicle-mounted sensor 200, the cleaning liquid passage 9 configured to connect the pump 3 to the nozzle 4 for a lamp and the nozzle 5 for a sensor, and the controller 8 configured to control the spraying of the cleaning liquid. Thereby, it is possible to remove the foreign matters attached to the headlamp 100 and the vehicle-mounted sensor 200 with the simple configuration.

Also, the electromagnetic valve 11 capable of controlling the flow of the cleaning liquid to the bifurcation passage is provided in the vicinity of the bifurcation part 12 of the cleaning liquid passage 9. For this reason, it is possible to control the supply of the cleaning liquid to the bifurcation passage by controlling the opening and closing of the electromagnetic valve 11. Therefore, it is possible to appropriately control the cleaning timings of the headlamp 100 and the vehicle-mounted sensor 200, which are different to-be-cleaned objects, by controlling the opening and closing of the electromagnetic valve 11.

Also, the electromagnetic valve 11 is provided on the way of the cleaning liquid passage 9A facing from the bifurcation part 12 toward the nozzle 4 for a lamp. For this reason, when the electromagnetic valve 11 is opened, the cleaning liquid can be sprayed from both the nozzle 4 for a lamp and the nozzle 5 for a sensor, and when the electromagnetic valve 11 is closed, the cleaning liquid can be sprayed from only the nozzle 5 for a sensor. For example, when the headlamp 100 is in the lights-out state, the electromagnetic valve 11 is subjected to the closed state, and when the headlamp 100 is turned on, the electromagnetic valve 11 can be subjected to the opened state. Therefore, when the headlamp 100 is in the lights-out state, only the vehicle-mounted sensor 200 can be cleaned, and when the headlamp 100 is turned on, the headlamp 100 can be cleaned, in addition to the vehicle-mounted sensor 200.

Also, the vehicle-mounted sensor 200 can be cleaned in cooperation with the cleaning of the windshield 300, and the vehicle-mounted sensor 200 can be cleaned even when the vehicle-mounted sensor 200 is detected as being smudged. Therefore, it is possible to appropriately clean the vehicle-mounted sensor 200, when needed, irrespective of the cleaning timing of the headlamp 100.

Also, the valve opening pressure of the check valve 51 of the nozzle 5 for a sensor is set higher than the valve opening pressure of the check valve 41 of the nozzle 4 for a lamp. For this reason, it is possible to reduce the spraying amount of the cleaning liquid at the vehicle-mounted sensor 200-side, which has a relatively smaller to-be-cleaned area than the headlamp 100, so that it is possible to suppress the consumption.

Like this, according to the vehicular cleaner system 1, it is possible to effectively remove the foreign matters attached to the plurality of different types of to-be-cleaned objects with the simple configuration and control.

Also, according to the vehicular cleaner system 1, for example, it is possible to clean even the vehicle-mounted sensor 200 together with the headlamp 100 by extending a cleaner configuration of the vehicular lamp of the related art.

Also, the high-pressure air nozzle 7 capable of spraying the high-pressure air toward the vehicle-mounted sensor 200 is provided, and the spraying of the cleaning liquid from the nozzle 5 for a sensor and the spraying of the high-pressure air from the high-pressure air nozzle 7 can be executed in a duplicate or switching manner. Therefore, it is possible to further effectively remove the foreign matters attached to the vehicle-mounted sensor 200. For example, the spraying of the high-pressure air from the high-pressure air nozzle 7 is initiated after the spraying of the cleaning liquid from the nozzle 5 for a sensor has been initiated, so that it is possible to remove the cleaning liquid, which has been attached to the vehicle-mounted sensor 200 upon the cleaning, by the spraying of the high-pressure air.

### MODIFIED EMBODIMENTS

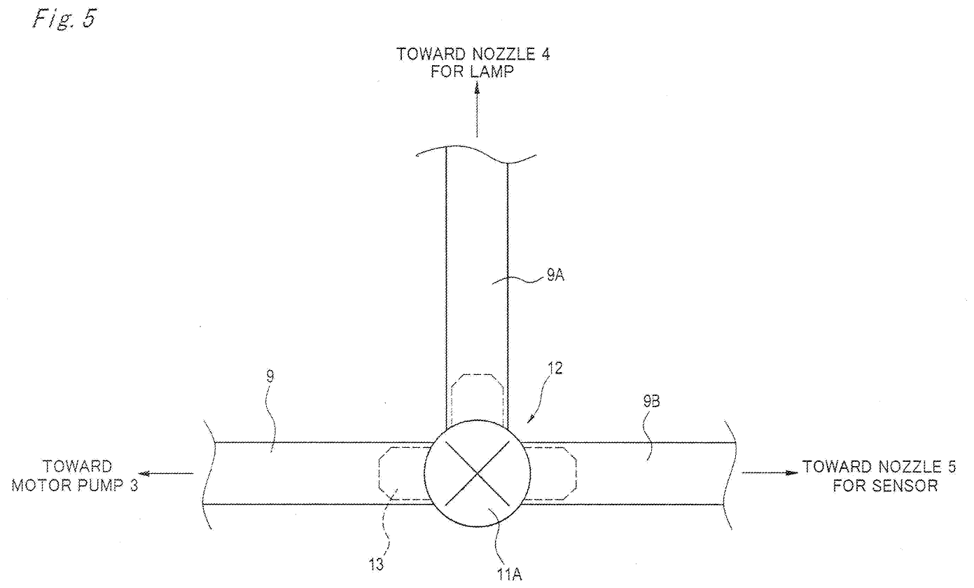

Subsequently, a modified embodiment of the arrangement of the electromagnetic valve 11 on the cleaning liquid passage 9 is described with reference to FIG. 5. In the meantime, since the parts denoted with the same reference numerals as the above exemplary embodiment have the same functions, the overlapping descriptions thereof are omitted.

In the cleaning liquid passage 9 of the above exemplary embodiment, the electromagnetic valve 11 is arranged on the way of the cleaning liquid passage 9A (refer to FIG. 2). In contrast, as shown in FIG. 5, in a modified embodiment, an electromagnetic valve 11A is arranged on the bifurcation part 12 of the cleaning liquid passage 9.

In this case, by controlling the opening and closing of the electromagnetic valve 11A, it is possible to enable the cleaning liquid, which has been delivered from the motor pump 3 to the cleaning liquid passage 9, to flow only through the cleaning liquid passage 9A, thereby cleaning only the headlamp 100. Also, the cleaning liquid can be enabled to flow only through the cleaning liquid passage 9B, thereby cleaning only the vehicle-mounted sensor 200. Also, the cleaning liquid can be enabled to flow through both the cleaning liquid passage 9A and the cleaning liquid passage 9B, thereby cleaning both the headlamp 100 and the vehicle-mounted sensor 200. Also, the cleaning liquid can be controlled not to flow through any of the cleaning liquid passage 9A and the cleaning liquid passage 9B.

According to the above configuration, it is possible to clean the different types of to-be-cleaned objects at more appropriate cleaning timings by controlling the opening and closing of the electromagnetic valve 11A.

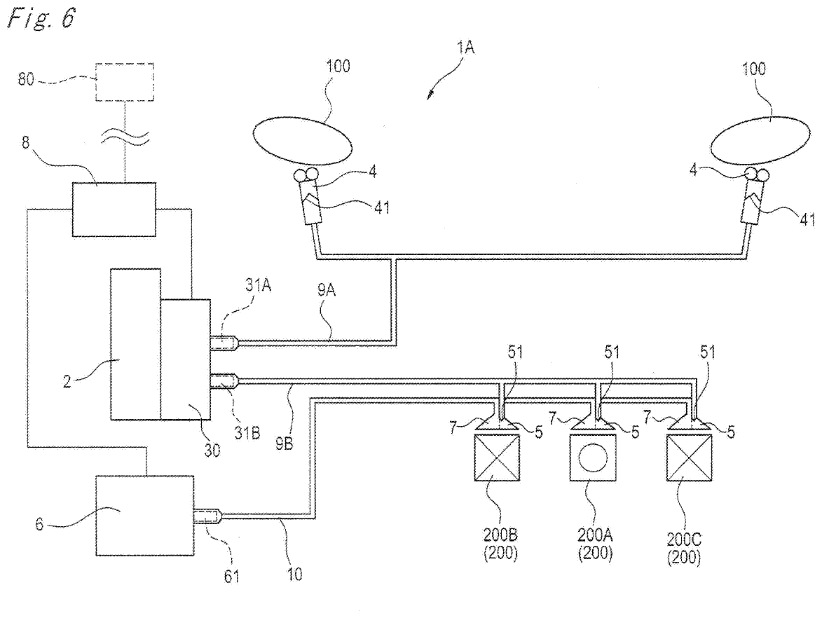

Subsequently, a modified embodiment of the vehicular cleaner system 1 is described with reference to FIG. 6. In the meantime, since the parts denoted with the same reference numerals as the above exemplary embodiment have the same functions, the overlapping descriptions thereof are omitted.

In the vehicular cleaner system 1 of the above exemplary embodiment, the motor pump 3 having the single cleaning liquid ejection port 31 is provided (refer to FIG. 2). In contrast, as shown in FIG. 6, a vehicular cleaner system 1A of a modified embodiment includes a motor pump 30 having a plurality of (two, in this example) cleaning liquid ejection ports 31A, 31B.

The cleaning liquid ejection port 31A (an example of the first ejection port) is coupled with the cleaning liquid passage 9A (an example of the first passage) through which the ejected cleaning liquid is to pass. The cleaning liquid ejection port 31A is connected to the nozzle 4 for a lamp via the cleaning liquid passage 9A. The cleaning liquid ejection port 31B (an example of the second ejection port) is coupled with the cleaning liquid passage 9B (an example of the second passage) through which the ejected cleaning liquid is to pass. The cleaning liquid ejection port 31B is connected to the nozzle 5 for a sensor via the cleaning liquid passage 9B.

The cleaning liquid is ejected through the cleaning liquid ejection port 31A upon forward rotation of the motor pump 30. The cleaning liquid is ejected through the cleaning liquid ejection port 31B upon reverse rotation of the motor pump 30. Therefore, upon the forward rotation of the motor pump 30, the cleaning liquid is sprayed from the nozzle 4 for a lamp, so that the headlamp 100 is cleaned. Upon the reverse rotation of the motor pump 30, the cleaning liquid is sprayed from the nozzle 5 for a sensor, so that the vehicle-mounted sensor 200 is cleaned.

An ejection pressure of the cleaning liquid to be ejected from the cleaning liquid ejection port 31A is set higher than an ejection pressure of the cleaning liquid to be ejected from the cleaning liquid ejection port 31B. Therefore, for example, a flow rate of the cleaning liquid to be ejected from the cleaning liquid ejection port 31A upon the reverse rotation of the motor pump 30 is smaller than a flow rate of the cleaning liquid to be ejected from the cleaning liquid ejection port 31A upon the forward rotation of the motor pump 30.

Operations of the vehicular cleaner system 1A are described, as follows.

Like the vehicular cleaner system 1, for example, when the lamp switch, the sensor cleaning switch, the lamp cleaning switch, and the windshield cleaning switch are operated or when the vehicle-mounted sensor 200 is detected as being smudged, each signal is transmitted from the vehicle ECU 80 to the controller 8. The controller 8 determines a rotating direction of the motor pump 30, based on the lighting or the lights-out state of the headlamp 100, and the on-operation of any one of the sensor cleaning switch (an example of the actuation switch), the lamp cleaning switch (an example of the actuation switch) and the windshield cleaning switch. Also, the controller 8 determines the rotating direction of the motor pump 30, based on the lighting or the lights-out state of the headlamp 100, and the smudge detection of the vehicle-mounted sensor 200.

According to the above configuration, it is possible to appropriately clean the headlamp 100 and the vehicle-mounted sensor 200, which are the different types of to-be-cleaned objects, by controlling the rotating direction of the motor pump 30. Also, since the ejection pressure of the cleaning liquid from the cleaning liquid ejection port 31A is set higher than the ejection pressure of the cleaning liquid from the cleaning liquid ejection port 31B, it is possible to suppress the consumption of the cleaning liquid at the vehicle-mounted sensor 200-side having a relatively smaller to-be-cleaned area, as compared to the headlamp 100. Also, the rotating direction of the motor pump 30 is controlled in accordance with the operation information and the like of the diverse switches, so that it is possible to appropriately switch the cleaning of the headlamp 100 and the cleaning of the vehicle-mounted sensor 200.

In the meantime, the present invention is not limited to the above embodiments, and can be appropriately modified and improved. In addition, the materials, shapes, sizes, numerical values, forms, numbers, arrangement places and the like of the constitutional elements of the above embodiments are arbitrary and are not particularly limited inasmuch as the present invention can be implemented.

In the above embodiments, the vehicle-mounted sensor is cleaned together with the cleaning of the vehicular lamp (for example, the headlamp 100). However, the present invention is not limited thereto. For example, at least one of the vehicular lamp and the vehicle-mounted sensor may be cleaned together with the cleaning of the windshield. According to this configuration, it is possible to clean even the vehicular lamp and the vehicle-mounted sensor together with the vehicle window such as the windshield by extending a configuration of the window washer of the related art.

The subject application is based on Japanese Patent Application No. 2017-9254 filed on Jan. 23, 2017, the contents of which are incorporated herein by reference.

1. A vehicular cleaner system comprising:
a tank configured to accommodate therein a cleaning liquid;
a pump configured to pressure-feed the cleaning liquid in the tank;
a first nozzle configured to spray the cleaning liquid toward a first to-be-cleaned object;
a second nozzle configured to spray the cleaning liquid toward a second to-be-cleaned object different from the first to-be-cleaned object;
a cleaning liquid passage configured to connect the pump to the first nozzle and the second nozzle, and
a controller configured to control the spraying of the cleaning liquid.

2. The vehicular cleaner system according to claim 1, wherein the cleaning liquid passage has a bifurcation part for supplying the cleaning liquid from the pump to each of the first nozzle and the second nozzle, and
wherein an electromagnetic valve of which opening and closing can be controlled by the controller is provided in the vicinity of the bifurcation part.

3. The vehicular cleaner system according to claim 2, wherein the electromagnetic valve is arranged on the way of the cleaning liquid passage facing from the bifurcation part toward the first nozzle.

4. The vehicular cleaner system according to claim 1, wherein the first to-be-cleaned object is a vehicular lamp, and
wherein the second to-be-cleaned object is a vehicle-mounted sensor that is to be mounted to a vehicle.

5. The vehicular cleaner system according to claim 4, wherein the controller is configured to spray the cleaning liquid from the second nozzle, in synchronization with an actuation of a window washer for cleaning a window of the vehicle or on the basis of a smudge detection result of the vehicle-mounted sensor.

6. The vehicular cleaner system according to claim 4, wherein when the vehicular lamp is in a lights-out state, the controller closes the electromagnetic valve, and when the vehicular lamp is turned on, the controller opens the electromagnetic valve.

7. The vehicular cleaner system according to claim 4, wherein the second nozzle has a check valve, and
wherein a valve opening pressure of the second nozzle is set higher than a valve opening pressure of the first nozzle.

8. The vehicular cleaner system according to claim 1, wherein the pump has a first ejection port through which the cleaning liquid is to be ejected upon forward rotation of the pump, and a second ejection port through which the cleaning liquid is to be ejected upon reverse rotation of the pump, and
wherein the cleaning liquid passage is configured by a first passage configured to connect the first ejection port and the first nozzle therebetween, and a second passage configured to connect the second ejection port and the second nozzle therebetween.

9. The vehicular cleaner system according to claim 8, wherein an ejection pressure of the cleaning liquid from the first ejection port is set higher than an ejection pressure of the cleaning liquid from the second ejection port.

10. The vehicular cleaner system according to claim 8, wherein the first to-be-cleaned object is a vehicular lamp,
wherein the second to-be-cleaned object is a vehicle-mounted sensor that is to be mounted to a vehicle, and
wherein the controller is configured to determine whether the vehicular lamp is turned on or not, and to control a rotating direction of the pump, based on any one of a result of the determination as to whether the lighting or lights-out, an on/off state of an actuation switch of the vehicular cleaner system, an actuation state of a window washer for cleaning a window of the vehicle, and a smudge detection result of the vehicle-mounted sensor.

11. The vehicular cleaner system according to claim 1, wherein the first to-be-cleaned object is a window of a vehicle, and
wherein the second to-be-cleaned object is at least one of a vehicular lamp and a vehicle-mounted sensor.

12. The vehicular cleaner system according to claim 1, further comprising:
a high-pressure air generation unit configured to generate a high-pressure air, and
a third nozzle configured to spray the high-pressure air toward the second to-be-cleaned object,
wherein the controller is configured to execute the spraying of the cleaning liquid from the second nozzle and the spraying of the high-pressure air from the third nozzle in a duplicate or switching manner.

13. The vehicular cleaner system according to claim 12, wherein the controller is configured to initiate the spraying of the high-pressure air from the third nozzle after the spraying of the cleaning liquid from the second nozzle has been initiated.

14. The vehicular cleaner system according to claim 4, wherein the vehicle-mounted sensor comprises at least one of a vehicle-mounted camera, a millimeter wave radar, and a LiDAR.

15. A vehicle comprising the vehicular cleaner system according to claim 1.
